(19) United States
(12) Patent Application Publication
(10) Pub. No.: US 2025/0086994 A1
(43) Pub. Date: Mar. 13, 2025

(54) METHODS AND SYSTEMS FOR DETERMINING AN OBJECT MAP

(71) Applicant: United States Government as Represented by the Department of Veterans Affairs, Washington, DC (US)

(72) Inventor: Andrew Schaumberg, Washington, DC (US)

(21) Appl. No.: 18/828,481

(22) Filed: Sep. 9, 2024

Related U.S. Application Data
(60) Provisional application No. 63/581,408, filed on Sep. 8, 2023.

(51) Int. Cl. G06V 20/69; G06T 7/00; G06T 7/13

(52) U.S. Cl. CPC G06V 20/695; G06T 7/0002; G06T 7/13; G06T 2207/30168

(57) ABSTRACT

A method and systems for automatically determining and classifying quality control issues in slide image data are disclosed. A method includes receiving image data associated with a slide, and determining, based on the image data, information associated with one or more pixels in the image data. The method further includes determining based on the information associated with the one or more pixels in the image data, one or more quality control indications; and identifying, based on the one or more quality control indications, the slide as quality control deficient.

### CROSS-REFERENCE TO RELATED APPLICATION

This application claims priority to U.S. Provisional Application No. 63/581,408 filed Sep. 8, 2023, which is herein incorporated by reference in its entirety.

### BACKGROUND

In the field of computational pathology, the central datatype is the whole slide image. A whole slide image is produced by digitally scanning at high magnification a glass microscopy slide of excised human tissue. To render a diagnosis for a patient, a pathologist may use a computer to view the whole slide image. Artificial intelligence tools may use whole slide images to predict survival, treatment response, and much more.

In a research study, there may be thousands of slides to review, which is too much for a human that has other work to do. For example, the VA Imaging Core must ingest digitized whole slide images from VA sites nationwide. These VA sites have different protocols to prepare slides. For instance, different sites may (1) use different formulations of hematoxylin and eosin (H&E) stains, (2) prepare their slides manually or with an automated robotic procedure, or (3) store their slides in the open or in dark humidity-controlled environments. Slide quality will vary from institution to institution, because everyone makes slides in slightly different ways. They may buy different formulations of stains, so the stains look different. Cheap stains may fade faster than expensive archival stains. Some institutions may make slides by hand—other institutions may use robots to make slides. Some institutions may store slides in the open, where the slides will age under continuous exposure to light. Other institutions may store slides in dark climate-controlled cabinets, where slides don't age much at all over time.

Stain formulation and preparation differences may contribute to slides having varying appearances (more red, more purple, more vibrant, more washed-out, presence/absence of fingerprint artifacts, etc) and aging at different rates, on a site-by-site basis. Slide storage has a profound impact on how slides age or otherwise break down over time. Much like how a car's brilliant shade of red paint may fade over decades of exposure to the sun's UV light, a slide's staining may fade with time, depending on the storage conditions of the slide and the stain formulation used. Moreover, the acrylamide layer that bonds the coverslip to the glass slide, may break down. As acrylamide breaks down with age, “window pane breaking” artifacts may form, and large bubbles may form as the acrylamide can no longer snugly hold the coverslip over the tissue and onto the glass slide.

Faded stain and large bubbles over the tissue are critical problems, and may make a slide useless both to (1) a pathologist seeking to inspect the slide to form a diagnosis for the patient, and (2) an algorithm to estimate survival, treatment response, or any other task. In these cases, if clinically justified, new slides may be prepared from stored tissue blocks. Alternatively, if there is no clinical justification to expend tissue from stored tissue blocks to make new slides, a labor-intensive process of restaining the aged slide must be performed, which is common case in research. Restaining involves solvating the slide in xylene to remove the coverslip, then applying fresh stain and acrylamide to the tissue, then applying a new coverslip over the prepared slide. This process is very slow, e.g. 1 technician may only be able to restain 20 slides in a day of work.

A separate problem is identifying which slides are needle biopsies, and which are not. Non-biopsy slides may be large ectomies, or other types of surgically resected tissue, such as transurethral resections (TURPs). A study may wish to focus analysis solely on needle biopsies, even if there are many non-biopsy slides in the digital archive. A quality control system that demonstrates its “understanding” of the tissue by classifying a whole slide image as biopsy or non-biopsy would greatly assist such studies, to focus solely on biopsies, for instance. Thus, there is a need for improved image analysis methods and systems.

### SUMMARY

It is to be understood that both the following general description and the following detailed description are exemplary and explanatory only and are not restrictive. In an embodiment, provided are methods and systems for identifying quality control suspect slides based on analysis of image data. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows a block diagram of an example system in accordance with embodiments described herein.

FIG. 2 shows a flowchart of an example method of image data preparation in accordance with embodiments described herein.

FIG. 3 shows an example method for preparing the iMASK file in accordance with embodiments described herein.

FIG. 4 shows an example method in accordance with embodiments of the disclosure.

FIG. 5 shows a system for error correction in accordance with embodiments of the present disclosure.

FIG. 6 depicts an example of orange stitching line artifacts in accordance with embodiments described herein.

FIG. 7 depicts an example of pen in accordance with embodiments described herein.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Described herein is a comprehensive quality control system for H&E slides, called “iQC” or “the system.” This system segments slide background, pen strokes, color marker, tissue pixels, “suspect” pixels, and other pixel types. The system includes an accelerated machine learning component to infer suspect pixels as tissue, pen, etc if the suspect pixels are similar to other pixels of tissue, pen, etc types. The iQC system additionally calculates statistics to estimate how faded the staining is for tissue pixels, and statistics for how many pixels are edges that may participate in a bubble's boundary. It also generates a number of statistics for the tissue dimensions and how “biopsy-like” or “ecotomy-like” a sample is. The system generates internal reports to facilitate manual slide review. The system generates external reports in spreadsheet format to share with collaborates and instruct them which slides are of low quality and need to be remade.

This quality control system will be an essential service of the new Imaging Core, as the core ingests data from VA sites nationwide and holds them all to high computationally-enforced standards. Such automation will allow the Imaging Core to scale its data ingestion efforts to many VA sites concurrently, without require detailed manual slide review efforts within the core. Rather, iQC spreadsheets will instruct each site which slides need to be remade and resubmitted to the core. Additionally, for downstream machine learning analysis, if slides have no problematic artifacts these slides may be recommended as suitable for diagnostic applications, whereas slides that have some problematic artifacts may not be suitable for diagnostic applications but may be broadly useful for machine learning to learn to represent histopathology, while slides that are badly faded may not be useful for any diagnostic or machine learning purpose.

The iQC data was validated to the extent possible in consultation with a histopathologist, who gave his opinion regarding the correctness of the results. This validation occurred both at the pixel level (are tissue pixels approximately correct, pen marks, etc) and at the statistical level (are stain fading, acrylamide aging, etc identified correctly).

Thus, the system provides for automatic quality control (e.g., image analysis to calculate quality metrics), decision support and reporting (e.g., slide quality rankings, pass/fail/review suggestions), and project management (e.g., collaborate spreadsheets for progress, tracking slide replacements, etc.).

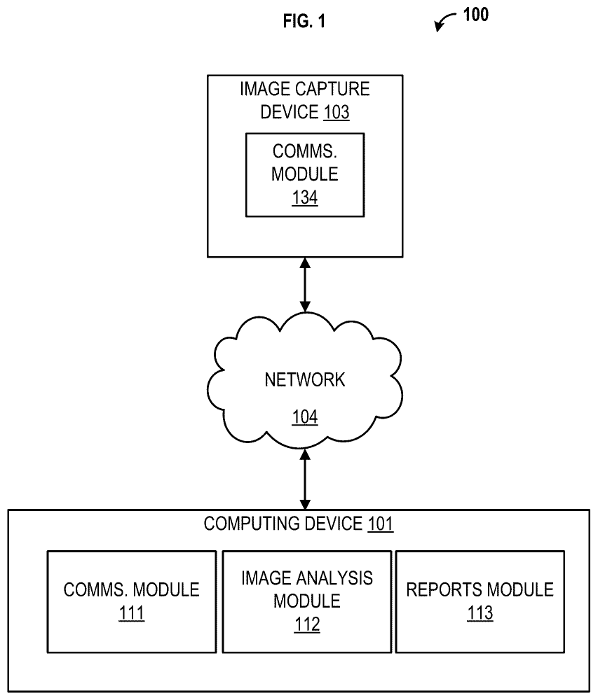

FIG. 1 shows a block diagram of an example system (e.g., iQC) 100 in accordance with embodiments described herein. The system 100 may comprise an image capture device 103. The image capture device 103 may comprise for example, one or more cameras, one or more microscopes, one or more video cameras, one or more other sensors, combinations thereof, and the like. The image capture device 103 may comprise a communications module 134. The communications module 134 may be configured to send, receive, store, encode, compress, or otherwise process data. For example, the communications module 134 may be configured to send and receive data to/from one or more other devices (e.g., the computing device) via the network 104. The network 104 may be an optical fiber network, a coaxial cable network, a hybrid fiber-coaxial network, a wireless network, a satellite system, a direct broadcast system, a local network, a wide area network, a public network, a private network, combinations thereof, and the like. The network 104 can be the Internet.

The computing device 101 may comprise a communication module 111, an image analysis module 112, and a reports module 113. The communications module 111 may be configured to send, receive, store, encode, compress, or otherwise process data. For example, the communications module 134 may be configured to send and receive data to/from one or more other devices (e.g., the image capture device 103) via the network 104.

The image analysis module 112 may be configured for blur detection. For example, the image analysis module 112 may be configured to determine one or more horizontal lines, which are artifacts that occur when the slide shakes in place. The shaking blurs the image during scanning. The present methods and systems provide an improvement over the art at least by detecting systematic blur by looking for the “stitching line” artifacts, which the system 100 indicates as lines in orange in some of the figures. It seems systematic blur is more common, where large rigid bands of blurring occur across an image.

The image analysis module 112 may detect degraded hematoxylin by determining red and/or blue values associated with one or more pixels (e.g., one or more red channels and/or one or more blue channels) and determine whether those values satisfy one or more thresholds.

The image analysis module 112 may detect one or more edges in image data. For example, the image analysis module 112 may employ Otsu's Method. Otsu's Method is a long-standing method to automatically determine a threshold in a set of values. Otsu's Method assumes the values are bimodal. The Otsu Threshold splits the set of values into two sets. The Otsu Threshold maximizes the variance between the sets and minimizes the variances within the sets. For example, Otsu's Method offers the system a means to “self-calibrate” a number of thresholds, including foreground/background thresholds and edge/non-edge thresholds. Additional approaches may include using the Canny Edge Detector, which uses a different thresholding approach.

The image analysis module 112 may detect pen in the image data. For example pen is detected at a location in the image, e.g. a strongly red pixel. The image analysis module 112 tentatively extends 8 lines from that location (up, diagonally up-right, right, down-right, down, down-left, left, up-left). If the line up to a specific maximum length connects to another pen of the same color, then both pen locations and the line in between are all pen additionally, all other tissue pixels within a specific radius of these points and line are marked as pen. This has several benefits: avoid some false positives for one-off pixels that may appear to be pen, because require multiple pen pixels of the same color may be required to be near each other, spanning only tissue (or suspect pixels) in between from the pre-programmed thresholds for red, green, blue, black, etc pen the system can learn in the image what other pixels may be this pen color. For instance, unsaturated red pixels may be in between two points of red pen, so the system has evidence that pixels of this unsaturated red color are also red pen. These unsaturated pixels are produced from the nature of the pen stroke: as a pen stroke is drawn, the pixels in between starting and ending points of a pen stroke tend to be less saturated in color as the pen ink is “drawn out”, and it is difficult to program “a priori” exactly what these unsaturated pen pixels will look like. This evidence of unsaturated pen color is important for the “accelerated scalable K-nearest-neighbor (KNN)” search, because anywhere in the image that identical unsaturated pen pixels are found, the KNN algorithm will then infer those pixels as pen. This gives a degree of flexibility in how pen is defined within an image, and is the core of the artificial intelligence component of the system 100

The image analysis module 112 may determine one or more background pixels in the image data. For example, an Accelerated scalable K-nearest-neighbor (KNN) search may be used. This approach uses a hashtable/dictionary. This technique does not compare one pixel to all other pixels, rather checks if a pixel (of an unknown class) has an exact match to a pixel (of a known class) in the image already. Then the pixel's unknown class is inferred to the known class. This is typically used on the “suspect” pixels indicated in orange. The task is to use KNN quickly to infer suspect pixels as background (the white/clear/empty part of a slide), tissue, pen, or marker. After inference, there is a better estimate of how much tissue there is in a slide and where the tissue is, so high-level image statistics for biopsy/nonbiopsy prediction may be calculated robustly. Only after attempting hashtable/dictionary lookups of a pixel, and pixels with similar values, is a more naïve KNN search performed that compares this pixel's value to all other unique pixel values in the image. Still, by considering only unique pixel values, the algorithm is much faster and scales well.

The image analysis module 112 may be configured to make a biopsy/non-biopsy prediction. The image analysis module 112 may leverage several algorithms, wherein each algorithm generates a score, each score is run through a Gompertz function, and various Gompertz functions are multiplied or added together to get a final score. If the final score is high, there is greater evidence this image is not a biopsy (a.k.a. “nonbiopsy”). Low scores suggest a biopsy.

This image analysis module 112 may analyze the visual appearance of the sample and determine, with high confidence, if this is a biopsy or not. Downstream AI analysis and scientific studies may wish to focus solely on biopsies, for instance, and ignore nonbiopsies. The Gompertz function may be defined to be mostly flat, then rise sharply, then taper off to reach a maximum value gradually. This flat region that is near zero is valuable. If many Gompertz function outputs are multiplied together, if any Gompertz function output is close to zero due to this flat region, then the product of the multiplication is also near zero. This allows one line of evidence to “veto” the nonbiopsy prediction, effectively forcing the prediction to be near zero and indicate the sample is a biopsy. A Gompertz output is near zero if there is little tissue in the slide, because biopsies typically excise far less tissue than an ectomy. Therefore having little tissue in the slide drives the biopsy predictor to zero, to favor a prediction of biopsy.

The biopsy/nonbiopsy prediction's structure is as follows, with the final biopsy/nonbiopsy score prediction being “qc_ectomy_not_biopsy_incl_bg_adjacent_stroma_score_sigmoid”. This score is high for ectomy/TURP/other-nonbiopsy, low for biopsy. The score is based on the narrowest extent of tissue (biopsies are thin), the amount of tissue (nonsuspect tissue includes inferred nonsuspect pixels, ectomies have more tissue), and the ratio of height-to-width of the tissue (biopsies are long and thin, while ectomies are rectangular). None of these measures are perfect indicators of biopsy/non-biopsy, but combined they may be more accurate at classification. The image analysis module 112 may add in the bg_adjacent_tissue_ratio_sigmoid_score term that makes fatty ectomies classify as ectomies not biopsies. The system may keep the overall score capped at 100000, which is 100*100*100 (the three main constituent scores multiplied together). This cap makes it intuitive to convert this score to something between 0 and 1, which looks like a probability.

A number of algorithms that generate important statistics to assess the quality of the image, as alluded to above (e.g. mmts is a statistic), may be used. These are typically shown in some way in the internal reports, discussed further below. Additionally, each slide has a metadata file with all of its calculated metrics.

The image analysis module 112 may be configured to determine one or more slide aging metrics. For example, fresh slides have vibrant color. Aged slides lose that, just as a vibrantly red car's color fades under years of sunlight. The image analysis module 112 may employ a metric to calculate the difference between the (red and blue channels) from the (green channel) in the tissue in the image to assess how faded the slide is. If there is a small difference, the slide is faded. If fading exceeds a threshold, the system fails the slide or recommends it for review.

The image analysis module 112 may be configured to determine one or more bubbles in the slide image data. Acrylamide in the slide breaks down with time, forming “window pane breaking” artifacts and bubbles. The system may calculate metrics to assess how much of a bubble's interface extends over the background of the slide. Poorer quality slides as have more of this. If this exceeds a threshold, the system fails the slide or recommends it for review.

The image analysis module 112 may be configured for barcode/text detection. Do not want to have patient names or PHI/PII printed on slide. The system identifies where black text is printed on the slide, and how much. If this exceeds a threshold, the system recommends the slide for review. Perhaps the slide should be better physically oriented in the scanner to avoid the text, or an opaque sticker applied over the text to protect PHI/PII.

The image analysis module 112 may be configured for debris detection. Excessive debris may partially occlude disease foci in the slide. If this exceeds a threshold, the image analysis module 112 may recommend the slide for review. Perhaps the slide should be cleaned and rescanned.

The image analysis module 112 may be configured to determine an inadequate tissue. For example, if the slide is mostly empty and has almost no tissue, then the image analysis module 112 may recommend the slide for review. This may be an inadequate biopsy. Inadequate tissue in general may make forming a diagnosis impossible.

The reports module 113 may be configured to generate one or more reports. For example, the present systems and methods may be configured to generate one or more internal reports. The one or more internal reports may comprise one or more HTML files, one or more web pages, combinations thereof, and the like. There may be trends, e.g. if many poor quality images some from a specific institution/site, then perhaps this site makes slides in a different way or stored slides under poor conditions so all the slides have deteriorated. This is called a batch effect. The whole batch of slides may be bad. The internal reporting tool, for instance, may comprise a systematic blur detector, reporting the slides with the strongest evidence of systematic blur. By identifying the “worst” slides in any particular category, like systematic blur, it is possible to triage slides for manual review. By manually reviewing the “worst” slides first, considerable time is saved, compared to looking at slides in no particular order, where most slides are of good quality. The internal reporting tool has many categories, e.g. the slides with the most blue pen, or other slides with the most debris, or most slide fading, etc. The internal reporting tool only reports a slide once. If a slide has ever been reported for any category, it is never reported again for any other category. This ensures that the internal report does not show redundant information. Redundant information may waste a reviewer's time.

The reports module 113 may be configured to generate one or more external reports. The one or more external reports may comprise one or more XLSX/Excel spreadsheets. They have slide IDs, quality control status, small pictures of the slide and corresponding quality control image from the system 100. The one or more reports may comprise one or more small images, one or more thumbnails, combinations thereof, and the like. The small image is derived from scaling down a medium-magnification slide from the “image pyramid” in the whole slide image. The small image is NOT derived from the thumbnail image. This is important security consideration. For security, the system may strip thumbnails from whole slide images. A thumbnail in the whole slide image may contain a patient name, barcode, or other PHI/PII. By removing thumbnail information, the system may make a de-identified research-ready dataset from whole slide images. For security, the small image based on the “image pyramid” will show a manual reviewer if there is any patient name or PHI/PII in the whole slide image. The system 100 “barcode detector” also tries to detect printed patient names in the image pyramid. The system may not strip the image pyramid for security reasons, because the image pyramid is the image data of interest in a whole slide image. If this information were stripped out, the whole slide image would be an empty file.

The system may strip thumbnails which are the most likely component of a whole slide image to have a patient name or other PHI/PII. barcode detector of the system 100 scans a portion of the image pyramid for printed text, such as barcodes and patient names. If the system 100 detects such text etc, the system 100 recommends the slide for manual review. In the external report spreadsheet, all slides are represented by a small image from the image pyramid, to encourage manual review of every slide for patient names or other PHI/PII.

Alongside the slide image, there may be corresponding quality control mask of the image. For each slide, there are not only images, but also the slide ID, quality control status (pass/review/fail etc), the biopsy/nonbiopsy status, a column to manually curate the biopsy/nonbiopsy status, and the biopsy/nonbiopsy score. A spreadsheet is readily adaptable by users who may add columns at their own discretion, (e.g a column to track which poor quality slides have been remade as fresh high quality slides). Such tracking in turns allows the spreadsheets to function as a project management tool, which records how quickly slides are being remade, and allows the system to forecast how many slides may be remade in the future. Taken together, the spreadsheet is a comprehensive slide review tool that is readily usable.

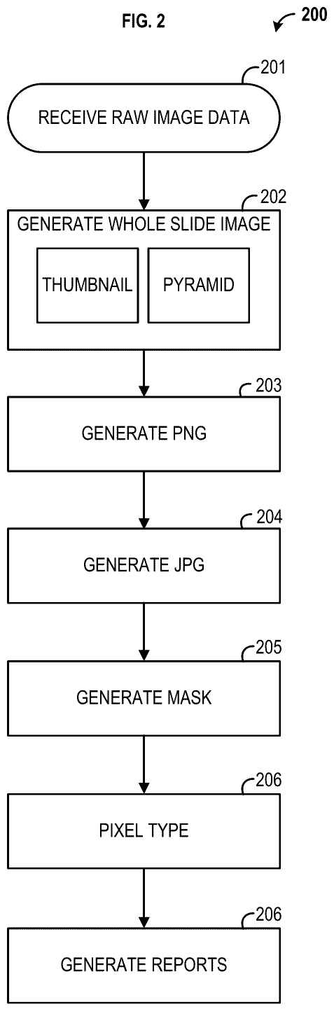

FIG. 2 shows a flowchart of an example method 200 of image data preparation in accordance with embodiments described herein. The image data preparation may be carried out, for example, by the computing device 101 (e.g., by the image analysis module 112).

At 201, raw image data may be received. The raw image data may be received for example from a camera and/or microscope (e.g., the image capture device 103). This data includes pixel-level details of the observed scene, with each pixel storing color or grayscale values representing the intensity of light at that specific point. For a camera, this could encompass a wide range of visual content, such as scenes, objects, or people. In the case of a microscope, raw image data often involves highly magnified views of microscopic specimens, revealing intricate cellular structures or particles. This data may also include metadata like exposure settings, timestamps, and spatial calibration, enabling precise analysis and reconstruction of the captured imagery for scientific, artistic, or diagnostic purposes. The image data may also include additional data as described below. For example: Metadata: Information about the image capture process, including camera or microscope settings, exposure time, aperture, ISO settings, focal length, and timestamp. This metadata helps in understanding the conditions under which the image was taken and is crucial for subsequent analysis or interpretation.

Geospatial Information: For some cameras and specialized microscopes, geolocation data may be included, providing the precise geographical coordinates of where the image was captured. This is particularly useful in applications like geology, ecology, and remote sensing. Calibration Data: Calibration information ensures the accuracy of measurements within the image. This may include data related to lens distortion correction, scale factors, and geometric transformations to accurately represent the physical world in the image. Color Profiles: For cameras, color profiles (such as sRGB, AdobeRGB, or ProPhoto RGB) may be embedded in the image data to define how colors are interpreted and displayed. This ensures consistent color representation across different devices and software.

Thumbnails and Previews: Smaller, lower-resolution versions of the image, often accompanied by metadata, for quick preview purposes. These can be helpful when browsing or managing a large collection of images. Annotation and Overlay Information: In scientific imaging or microscopy, annotations, scale bars, or other overlays may be included to label specific features or provide additional context within the image. Compression and Encoding Information: Details about the image compression method used (e.g., JPEG, TIFF, RAW) and any associated compression settings or quality factors. This information affects the image's file size and quality.

Sensor Data: In some cases, specialized cameras or microscopes may capture sensor-specific data, such as electron counts in a scientific camera or sensor calibration parameters. Image Sequencing Information: For microscopy, time-lapse imaging, or video capture, data about the frame rate, frame number, and temporal information may be included to reconstruct the sequence accurately. Spectral Information: In advanced imaging techniques like hyperspectral or multispectral imaging, raw data may include information about the intensity of light at different wavelengths, allowing for detailed spectral analysis.

At 202, one or more whole slide images (i_{wsi}) may be generated. Each whole slide image of the one or more whole slide images may comprise one or more thumbnail images and/or one or more pyramid images. i_{pyramid} has pixel data at high resolution typically suitable for diagnosis or downstream AI analysis. For example, the one or more i_{pyramid} files may comprise one or more high resolution scans of one or more levels of magnification. For example, L0 (level 0) is the highest-magnification level in the image pyramid, e.g. 400× magnification. There are typically so many pixels in L0 that this image cannot be directly exported to a PNG image file. Such high magnification is not necessarily required for quality control. Nuclei are plainly visible in L0. Loosely speaking, L0 is the “base” or “ground” level of the “pyramid”. L1 (level 1) is the second-highest magnification level, and is typically downsampled 4× from L0. Therefore L1 is typically 100× total magnification, which is just enough magnification for nuclei to be visible. Depending on the configuration of the scanner, more levels may be produced at progressively lower magnification. For example, L2 is often 16× downsampled from L0, but this may vary from 8-32x, depending on the scanner's configuration. L3 may be 32× downsampled from L0, this this may vary.

At 203, one or more PNG files may be generated (i_{png}). The one or more PNG files may be generated based on L1 of the pyramid image. At 204, one or more JPG files may be generated (ijpg). the one or more JPG files may be generated based on L1 of the pyramid image. At 205, one or more mask files may be generated (iₘₐₛₖ). iₘₐₛₖ may be a quality control mask produced by iQC. The iₘₐₛₖ pixels are a semantic segmentation of the ijpg pixels. That is, an iₘₐₛₖ pixel may indicate iQC's prediction for what type of pixel exists at the corresponding ijpg coordinate, e.g. is the pixel background, tissue, pen, suspect, an edge, etc. The height and width of ijpg and iₘₐₛₖ are identical, because each pixel in ijpg corresponds to the pixel in iₘₐₛₖ at the same cartesian coordinate.

At 206, the one or more pixels in any of the files may be typed (e.g., assigned a type) as described herein. At 207, one or more reports may be generated as described herein.

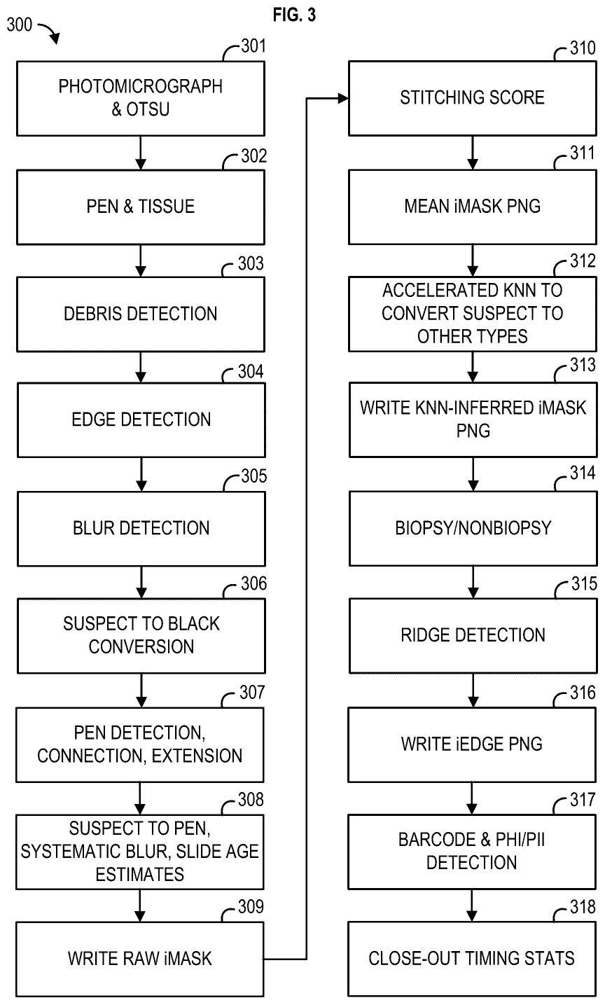

FIG. 3 shows an example method 300 for preparing the iMASK file in accordance with embodiments described herein. The example method 300 may be carried out via any one or more of the devices described here, including components of the system 100 of FIG. 1, such as the computing device 101. At 301, the system may perform photomicrograph detection and Otsu method thresholds. iQC's first step is to check if ijpg is derived from a whole slide image not a photomicrograph, and calculate various thresholds that may be used in subsequent steps. The thresholds themselves are descriptions of the image and its balance of colors and textures. Whole slide images have a white background. However, photomicrographs taken at a microscope's eyepiece have a black background and a circular field of view (fov). iQC should automatically detect a photomicrograph. The method 300 may include determining whether one or more pixels in the ijpg are logically black. The system may determine whether the image comprises a photomicrograph according to the procedure described in iₘₐₛₖ pixel typing step 1 of the Appendix filed with this specification (“Appendix”), which is herein incorporated by reference in its entirety. For example, to determine if ijpg is a whole slide image or photomicrograph, the system may define has_black_scope_fov (which is true for photomicrographs and false for whole slide images). This step is intended mark as logically black the pixels that are outside a microscope's field of view in a photomicrograph. For other pixels, grayscale value is calculated and saved for later reference. For example, the method 300 may comprise using Otsu's Method to calculate the otsu_{gray} threshold for the grayscale representation of the pixels in ijpg, for all pixels in the list_of_pixels to consider in the above step. For example, the method 300 may comprise calculating Otsu Thresholds for red, green, and blue channels, for pixels that are not logically black. These Thresholds are used for pen detection, and potentially other purposes. For example, the method 300 may comprise using Otsu's Method to calculate otsu_{red} threshold from list_of_pixels_{red}. For example, the method 300 may comprise using Otsu's Method to calculate the otsu_{green} Threshold from list_of_pixels_{green}. For example, the method 300 may comprise using Otsu's Method to calculate the otsu_{blue} threshold from list_of_pixels_{blue}. For example, the method may comprise applying a Sobel Filter is to the ijpg pixels, and calculating the Sobel Magnitude. A high Magnitude for a pixel is evidence in favor of the pixel being an edge. Otsu's Method may be used to calculate the threshold for which a Sobel Magnitude is great enough to be considered an edge. The method 300 may comprise using Otsu's Method to calculate the otsu_{sobel} threshold from list_of_pixels_{sobel}. For example, the method 300 may comprise defining a number of variables as especially strong or weak thresholds (as detailed in Appendix).

At 302, the system may automatically perform an initial (e.g., preliminary) typing of pen, tissue, one or more other pixel types, combinations thereof, and the like. For example, the method 300 may comprise storing the preliminary pixel type information in iₘₐₛₖ and in other data structures. Examples of other data structures mentioned include black_ary and gray_ary. Various types and thresholds may be defined, for example, as indicated in the Appendix. The method 300 may proceed through several levels of decisions, based on the value of a pixel_{jpg}. These decisions may establish a preliminary type of pixel_{jpg}. This type information may be saved in iₘₐₛₖ, and other variables may be updated. The red, green, blue channel values of a pixel_{jpg}, in addition to its Sobel magnitude, and the relative value of various Otsu Thresholds, all contribute to the typing. At this stage, a pixel may be typed as background, foreground, red pen, green pen, blue pen, black [pen, but may be tissue fold etc, tissue, or hematoxylin [tissue]. “Suspect” pixels may or may not be typed at this stage. For example, to determine if a pixel_{jpg} is approximately gray, the pixel's red, green, and blue channels are compared. If these channels are similar in value, then the pixel is typed as background. Alternatively, if the pixel has a low Sobel Magnitude, then this pixel is in a region where pixels are approximately the same brightness (which often occurs in the white background areas of ijpg), so the similarity thresholds for comparing red, green, and blue channels are less strict. That is, if there is low Sobel Magnitude, iQC allows greater differences among red, green, and blue channels to still type the pixel as background. For example, the method 300 may comprise letting abs (number) be the absolute value of number, e.g., abs (−7) is 7. For example, the system may make use of a number of hashtables/dictionaries to speed up computation. A dictionary may require a text string to function as a “key”, to instantly look up in the dictionary of there is a value that corresponds to the given key. The coord_key function makes a key from the given Y and X coordinates of a pixel. The system may define rgbs_key to make a “key” for the integer-valued red, green, blue, and Sobel Magnitude values of a pixel_{jpg}. In this way, the system may look up in a dictionary and instantly find if there is another pixel with the same red/green/blue/sobel values, which is highly scalable. The systems's KNN uses this instant lookup to quickly infer “suspect” pixels to pen, tissue, background, etc types in iₘₐₛₖ. The multi-level decisions for rule-based typing of pixels is often sufficient to assign a type to most pixels, but the accelerated KNN can type “suspect” pixels that do not fit cleanly into the rules. Importantly, the system can instantly lookup a pixel's value according to this “key”, and lookup similar values, e.g. a “key” that is different in the red channel by 1. This allows accelerated KNN to search for similar values, before resorting to a naïve KNN algorithm. The method 300 may comprise determining an edge near the center of the slide which may be indicative of one or more bubbles in i_{glass}.

At 303, debris may be detected. For example, the system types as debris small isolated regions of pixels surrounded by background pixels. Debris typically occurs because the slide (i_{glass}) is not clean. Alternatively, small bits of tissue or flecks of pen/marker may be typed as debris. The method 300 may proceed according to pixel typing step 3 as described in the Appendix.

At 304, one or more edges may be detected. When acrylamide ages, “window pane breaking” artifacts and bubbles may form. Both of these signs have well-defined edges. The system may detect edges to both describe ijpg and estimate the presence of these signs of age. The system may exclude debris from edge detection. By excluding debris, the count of edge pixels may be more accurate, so by extension the metrics to calculate how many pixels are edges related to window pane breaking or bubbles may be more accurate. The system may use of Otsu's Method to type a pixel as an edge or not. The Canny Edge Detector may use a different method to type pixels as edges or not. The system may be configured to detect the one or more edges as described in pixel typing step 4 of the Appendix.

At 305, the method 300 may determine blur. For example, the system may be configured to detect systematic blur. Evidence of systematic blur may comprise horizontal lines, which are artifacts that occur when the slide shakes in place. The shaking blurs the image during scanning. It's advantageous to look for these line artifacts than it is to look for blurred pixels directly. For example, a tissue pixel is “suspect” if the tissue pixel is a thin line between background fields (i.e. there are background pixels in iₘₐₛₖ on opposite sides of the suspect pixel in iₘₐₛₖ). This may be due to scanner stitching/scraping/shaking-in-place artifacts, which are typically lines running left-to-right, lengthwise along the slide. For example, a value may be “true” if an edge pixel is nearby, “false” otherwise. The variable “edge_ary” is an array that has a Boolean variable for each pixel in iₘₐₛₖ. This Boolean is true if the iₘₐₛₖ pixel is an edge, false otherwise. iₘₐₛₖ does not directly have a specific type for edges, (e.g., edges are encoded as black pixels, but tissue folds and black pen or black marker all fall under the “black pixel” type in iₘₐₛₖ). There is an edge type in i_{edge}, but checking ledge would require three comparisons (red, green, and blue channels) which is less computational efficient that checking true/false values in edge_ary. The method 300 may proceed to according to the steps described in pixel typing step 5 of the Appendix.

At 306, one or more suspect pixels may be converted to one or more black pixels. For example, the system may convert “suspect” type pixels to “black” type pixels according to rules and Otsu Thresholds for ijpg. For example, a suspect pixelₘₐₛₖ is typed to black if the grayscale value of the corresponding pixel_{jpg} is less than otsu_{gray}_weak and this pixel is not an edge. If this pixel is typed to be black, then the pen_pixels counter is incremented by one, because this pixel may be black pen. The coordinates of this pixel are saved for later use, in case all black pixels must be enumerated efficiently, without exhaustively searching iₘₐₛₖ for black type pixels. The method 300 may proceed according to the steps described in pixel typing step 6 in the Appendix.

At 307, one more pen pixel types may be determined. For example, for every red, green, blue, or black pen pixelₘₐₛₖ, the system attempts to make straight lines connecting two pen pixels having the same type (e.g. red pixel may connect to a red pixel, blue pixel may connect to a blue pixel), then flood fill through suspect pixels that are not stitching artifacts. The extent of flood fill is limited to a specific distance away from where the flood fill started, which prevents flood fill from overwriting large portions of iₘₐₛₖ with pen pixel types. A number of variables may be defined according to the details in pixel typing step 7 of the Appendix. The method 300 may further comprise, for each pen pixelₘₐₛₖ type (red, green, blue, or black) as listed in rgb_pen_pixel_coords (so not every pixel in iₘₐₛₖ needs to be enumerated and checked for pen status), the connect_rgb_pen_iteration function is called to extend a line over suspect pixels to connect a pen pixel to any nearby pen pixel of the same type. Any overwritten suspect pixels are typed as pen of the appropriate color. In this way, even though the intervening suspect pixels did not fit the rules that define what pen is in “iₘₐₛₖ pixel typing: step 2: initial typing of pen, tissue, etc”, these suspect pixels and their RGB+sobel values are now known to be pen of that color. This knowledge serves as training data to the accelerated KNN classifier in “iₘₐₛₖ pixel typing: step 12: Accelerated KNN inference for conversion of suspect pixels to other pixel types”, so these RGB+sobel values may be generally inferred to be red, green, or blue pixels as appropriate. Black type pixels are not inferred in the KNN step, because black pixels may arise for so many non-pen reasons (e.g. bubbles, necrosis, tissue folds, etc). Additionally, any overwritten suspect pixels are subjected to the flood_fill function, which overwrites nearby suspect pixel types (and other types as appropriate). In this way, both the line of suspect pixels between pen pixels are overwritten as pen, as well as suspect or other pixel types in the neighborhood of this line, out to a specified maximum distance away from the line. This spatially constrains how many suspect and other pixel types are overwritten as pen. For example, a connect_rgb_pen_iteration function checks that the pixel mask at coordinate coord_y and coord_x is a pen type (red, green, blue, or black pen/marker), and that there are pixels in the nearby spatial neighborhood that are of the same type as pixelₘₐₛₖ. Because black type pixels may occur for many reasons (e.g. these pixels may be tissue folds, bubble edges, necrosis, etc and so are not necessarily specifically pen), more pixels in the neighborhood must be of the black type and the checked neighborhood is larger. Either way, if all these checks pass as appropriate, then connect_rgb_pen is called to attempt to connect this pen pixel to another nearby pen pixel of the same type in a straight line over suspect pixels. For example, the connect_rgb_pen function calls the connect_rgb_pen_direction eight times, in an attempt to connect in a straight line two pen pixels of the same type, so suspect pixels across and near that line may be inferred as pen. To extend this line, only suspect pixels are traversable. The line extension process will stop if any other pixel types are encountered, e.g. background or nonsuspect tissue. For example, the connect_rgb_pen_direction function may extend a line from coord_x and coord_y; starting initial_jump_to_find_adjacent_pen pixels away; the pixelₘₐₛₖ type encoded by pen_r, pen_g, and pen_b; in the direction delta_y, delta_x; until a pixelₘₐₛₖ of the same type is encountered or max_suspect_overwrite_distance is reached. In this way, connect_rgb_pen_direction may be used to connect a pen pixel to another pen pixel in above (delta_y=−1, delta_x=0), diagonally down to the right (delta_y=1, delta_x=1), etc. By requiring that two pen pixels of the same type must connect in a straight line within minimum and maximum distance constraints, the system less often falsely infers suspect pixels as pen. Many pixels of corroborating evidence in specific spatial patterns are required. The method 300 may comprise one or more steps detailed in pixel typing step 7 of the Appendix.

At 308, one or more suspect pixels may be converted to one or more other pixel types. For example, the system may counts tissue and suspect pixels, replacing tissue pixels with pen if tissue pixel is surrounded by pen or background (which should remove any false tissue perimeter from pen marks). For example, the between_pen_or_background_row function computes over one entire row in iₘₐₛₖ, to achieve a few tissue-related tasks: (1) each background pixelₘₐₛₖ in the row is appended to a list; (2) if a pixelₘₐₛₖ in the row is nonsuspect tissue in between two pen pixels of the same color, then the pixel mask is retyped to that pen. This is a remarkable operation for this algorithm, as it is the only instance that a nonsuspect pixel is inferred as a different type in this algorithm. Such nonsuspect tissue pixels between pen pixels are presumed to be better typed as pen because there is great evidence in this pixel neighborhood in favor of pen; (3) otherwise, a nonsuspect tissue pixelₘₐₛₖ is appended both to the list of nonsuspect pixels and to the list tissue pixels, for the row; and (4) if a pixelₘₐₛₖ is suspect, then the pixelₘₐₛₖ is appended both to the list of suspect pixels and to the list tissue pixels, for the row. For example, for each row in iₘₐₛₖ, between_pen_or_background_row is called, to generate a lists of pixel coordinates, i.e. a list of nonsuspect tissue pixels, a list of suspect tissue pixels, and a list of tissue pixels. Counts are maintained to track how many pixels there are of various types, for reporting and analysis purposes. The coordinates of each pixel type are saved to a type-specific hashtable/dictionary, for instantaneous lookup for the accelerated KNN step later. For example, the between_pen_or_background function checks if a pixel mask at a given coord_y and coord_x is between (a) a pen pixelₘₐₛₖ in one corner and (b) either the same type of pen or a background pixelₘₐₛₖ. The “corner” is defined as a pixel in the corner of a 3×3 pixel neighborhood with coord_y, coord_x at the center of the 3×3. There are four corners. In this way, between_pen_or_background is a computationally efficient approximate check if this pixelₘₐₛₖ at coord_y,coord_x is (1) a part is a continuous pen stroke or (2) is the end of a pen stroke. Through between_pen_or_background the system may ensure there is more than one pixel of evidence in support of the pixel at coord_y,coord_x truly being a pen pixel, rather than random noise that may appear to be pen. The between_pen_or_background function returns the pen type (red, green, or blue—not black) that this pixel is between. Otherwise, a background pixel is returned, to indicate this pixel is not between pen pixels. The system may calculate, saves, and prints to a CSV/spreadsheet file a number of statistics, because iₘₐₛₖ has nearly complete type information for ijpg. Accelerated KNN has not been performed yet to infer suspect pixels as other pixel types. So, printing these statistics now is an important reference to measure later how many pixels types have been changed by KNN. The method 300 may comprise performing a number of mean red/green/blue calculations, which may be used later for stain fading detection. Well-stained tissue should have strong/high reds and blues, but weak/low greens. Strength is low for understained slides and high for overstained slides. The system may use two complementary methods to estimate stain strength. The first method is based on the mean and standard deviation, which is a simple baseline. The second is based on the grouped median, where the “median tissue pixel” may be a stromal pixel, if most pixels are stroma. A minority of pixels are expected be cell nuclei, lymphocytes, etc. The system may let the grouped median be the 50^{th} percentile of the data. The formula for the grouped median is:

$$grouped\_median = L + \frac{i ( \frac{n}{2} - c )}{f}$$

where:
L is the lower limit of the median interval. i is the interval width of the group, which is exactly 1, for integer pixel values like ours that take a value from 0 to 255 inclusive. c is the number of data points below the median interval. n is the total number of data points. f is the number of datapoints in the median interval, e.g. if there are four “2” values, the interval width is four. For example, the grouped_median of [1, 2, 2, 2, 2, 3, 4, 5, 6] is 2.375. The simple median is 2. For this grouped median: L=(2−0.5)=1.5, i=4, c=1, n=9, f=4, therefore

$$grouped\_median = 1.5 + \frac{1 * ( \frac{9}{2} - 1 )}{4} = 2.375 .$$

The system may be configured to calculate, save to CSV, and print statistics relating to how crisp (i.e. not blurry) the tissue pixels are. This crispness is defined by a Sobel Magnitude. This crispness should not be confused with systematic blur. Tissue is crisp when tissue pixels tend to have different grayscale values when compared to adjacent pixels. A freshly-stained slide will tend to be more vibrantly-stained and more “crisp” than an aged slide, as fresh stains will highlight differences among tissues well. The method 300 may comprise determining one or more slide aging metrics based on stain strength and/or systematic blur. For example, a slide age estimate may be defined as a stain strength metric multiplied by a tissue crispness metric. The intuition for this is aged slides with faded stain will have both (1) low stain strength because stain has faded to gray, and (2) low tissue crispness because old stain does not vibrantly highlight differences among adjacent tissues. The intuition continues that for new freshly-stained slides there will have both (1) high stain strength because reds (from eosin) and blues (from hematoxylin) will be much stronger then greens (neither hematoxylin or eosin is green) in ijpg and (2) high tissue crispness because fresh stain will vibrantly highlight differences among adjacent tissues. The method 300 may comprise one or more steps detail in pixel typing step 8 of the Appendix.

At 309, the method 300 may comprise writing a raw iₘₐₛₖ PNG file. For example, each pixel in ijpg has a corresponding type in iₘₐₛₖ. The iₘₐₛₖ image is written as a PNG, where types are color-coded as outlines in the system legend/key, e.g. background pixel types are white, tissue pixel types are magenta, suspect pixel types are orange, etc. The method 300 may implement an image analysis algorithm lamba (2). For example, the system needs an approximate measurement of how “contiguous” a line of pixels is. For example, if there are many consecutive “suspect” pixelₘₐₛₖ in iₘₐₛₖ, then this is evidence in favor of systematic blur. It is acceptable if this “line” of consecutive “suspect” pixels is “broken” occasionally with background pixels, but these breaks should be small. (b) If there are many consecutive pixel pairs, such that a suspect pixelₘₐₛₖ is immediately above a nonsuspect pixelₘₐₛₖ in iₘₐₛₖ, then this is evidence in favor of systematic blur. It is acceptable if this “line” of consecutive “suspect” pixel pairs is “broken” occasionally with background pixels, but these breaks should be small. (c) If there are many consecutive nonsuspect tissue pixelₘₐₛₖ along a row of iₘₐₛₖ then this is a measurement of the approximate width of the tissue sample, which in turn be evidence in a favor of a particular sample type, e.g. a biopsy or a nonbiopsy. (d) If there are many consecutive nonsuspect tissue pixelₘₐₛₖ along a column of iₘₐₛₖ then this is a measurement of the approximate height of the tissue sample, which in turn be evidence in a favor of a particular sample type, e.g. a biopsy or a nonbiopsy. In general, this contiguity measurement algorithm takes the following form, either λ^{row} (for horizontal paths) or λ^{column} (for vertical paths), below. It is possible in principle to define λ along a path that is nonlinear, or along a sloped linear path that is neither horizontal nor vertical. The method 300 may comprise one or more steps detailed in pixel typing step 9 of the Appendix.

At 310, the system may calculate one or more stitching scores for horizontal or vertical bars in order to detect systematic blur. For example, the system may be configured to detect if stitching artifacts run left-right (horizontally) or up-down (vertically). The blur boundary will be parallel to stitching artifacts, if there is a blur boundary. So if there are horizontal stitching artifacts, there will also be horizontal bands of systematic blur. In systematic blur, there are both stitching artifacts and bands of consistently blurred pixels. The system may be configured to detect a band of blur by comparing the Sobel Magnitude of a pixel to a nearby pixel's Sobel Magnitude. The pixels compared depends on the direction (horizontal or vertical) of the stitching artifacts. For example, some evidence of Systematic Blur is one row of crisp/sharp/non-blurry pixels above one row of blurry pixels, where stitching artifacts are horizontal. The detect_blur_row function directly compares two rows of iₘₐₛₖ pixels to detect if there is systematic blur in the horizontal direction. What is compared here are suspect pixel types to nonsuspect+hematoxylin pixel types. This is corroborating evidence to the “stitching rows” approach, which detects systematic blur by looking for lines of suspect pixels in the slide background. For example, the method 300 comprise first, the detect_blur_row function counts how many nonsuspect or hematoxylin pixels there are in the coord_y row of iₘₐₛₖ. Second, the detect_blur_row function counts how many nonsuspect or hematoxylin pixels there are in the coord_y_compare row of iₘₐₛₖ. coord_y_compare is coord_y-blur_offset, which here means 5 rows above coord_y. Therefore, these two nearby (but not adjacent) rows of iₘₐₛₖ pixels will be compared. The system may be configured to order to determine which row is more likely (or equally likely) to have systematic blur, even if there is systematic blur at all If the first count is greater than (or equal to) the second count, then detect_blur_row will check for systematic blur in row coord_y_compare. Otherwise, detect_blur_row will check for systematic blur in row coord_y. The method 300 may comprise one or more steps included in pixel typing step 10 of the Appendix.

At 311, the method 300 may comprise writing a mean iₘₐₛₖ PNG file that is iₘₐₛₖ mixed with ijpg.

At 312, the method 300 may comprise performing an accelerated KNN (K nearest neighbors) inference to convert one or more suspect pixels to one or more other pixel types. For example, it may be determined that not all pixels fit within the system's set of rules for background, pen, tissue, etc (per section “iₘₐₛₖ pixel typing: step 2: initial typing of pen, tissue, etc”). Many pixels may be typed as “suspect” in iₘₐₛₖ to indicate these pixels may be tissue, but the pixels may also be background, pen, etc. To infer the type of suspect pixels, the system may use the K-Nearest Neighbors (KNN) machine learning algorithm for ijpg and iₘₐₛₖ pixels. Specifically, for a given suspect pixel “p”, the system may use KNN to find the pixel “c”, where “c” has the most similar red, green, blue, and Sobel magnitude values to “p”. This is sometimes referred to as the “closest pair of points problem.” Then the system assigns the pixelₘₐₛₖ type of “c” to “p”. Thus “p” is no longer the suspect type. Instead, the type of “p” is equal to the type of “c”. This is the inductive bias of KNN, e.g. that the type of a pixel is most likely the same as the type of the most similar pixel. This is a very simple inductive bias that is readily interpretable. KNN may be considered the simplest possible machine learning algorithm, and so KNN is a logical first choice of machine learning algorithms, by Occam's razor. The performance and relative complexity of more advanced machine learning algorithms may then be compared to KNN. For every pixel_{jpg} in ijpg, the coord_key makes a “key” from the pixel_{jpg} red, green, blue, and Sobel magnitude values (a.k.a. RGBS). If there is a suspect pixel with this RGBS value, then this iQC assigns to that suspect pixel the type of the corresponding pixel with the same RGBS value. Importantly, a hashtable lookup is practically instantaneous, i.e. O(hashtable_lookup) ∈O(1). Loosely speaking, a hashtable lookup may be understood to take one computation, for the purposes of Big O notation. A hashtable lookup is very fast. This approach scales very well, e.g. if every suspect pixel may be found in the hashtable, best case performance of KNN is O(KNN_with_hashtable) E O(s), or more generally O(KNN_with_hashtable) ∈O(n). This is more computationally tractable, e.g. if there are on average 1000 suspect pixels to infer per image, the hashtable-accelerated KNN performs 1000 computations on this image, which several orders of magnitude less than 4500000000. This is also scalable to thousands of images in a dataset, e.g. (1000 computations/image)*(4000 images/dataset)=4000000 (4 million) computations for a dataset. Most of the time the hashtable must find a pixel with the same RGBS value as a suspect pixel, but this cannot always be guaranteed.

To increase the chance that the hashtable will find a matching RGBS value, the system may perform several hashtable lookups and slightly different RGBS values, e.g. if red is incremented or decremented by 1. Hashtable lookups remain fast, and several hashtable lookups is still a scalable way to compute KNN across all pixels. If H=(the total number of hashtable lookups to perform for each suspect pixel), then O(KNN_with_hashtable_and_many_lookups)∈O(s*H), or more generally O(KNN_with_hashtable_and_many_lookups) ∈O(n). That is, adding more hashtable lookups adds a linear computational complexity to KNN, which factors out of the Big O notation. The additional computational complexity is minimal. The choice of H may vary depending on the type to infer, e.g. the system uses a high H to infer suspect pixels as background and a much lower H to infer pixels as tissue, because there may be some variance in the background color within a i_{wsi} (due to lighting, artifacts, etc), whereas tissue staining is relatively uniform within an i_{wsi}. For the vast majority of the images in the data, this hashtable approach finds a KNN match for every pixel in ijpg. If a KNN match is not found through the hashtable, the system's algorithm falls back on a naïve KNN, which in practice is performed for fewer than 100 suspect pixels in an image on average. The system's approach thus remains computationally tractable and scalable in practice. A purely naïve KNN on a dataset may not complete after weeks of computation.

Thus, the present methods may be considered as a “fixed-radius near neighbors” algorithm, in that the red, green, blue, and Sobel magnitude values all fall on an integer lattice, which is used to perform hashtable lookups to find near neighbors. The present methods and systems may implement (1) use of a hashtable for fixed-radius search in a feature space (i.e. red, green, blue, and Sobel magnitude features of a pixel); (2) general use of fixed-radius search for the purpose of inferring the “type” of pixels in whole slide images; and (3) hashtable-accelerated fixed-radius KNN search also accelerates “naïve KNN”, because the system only searches for unique RGBS values. That is, if it is assumes there are infinitely many background pixels in i_{wsi}, but all these background pixels have identical red, green, blue, and Sobel magnitude values-then the system's hashtable-accelerated fixed-radius KNN will perform exactly one hashtable lookup for that specific red, green, blue, and Sobel magnitude. This single computational is vastly more efficient than a purely naïve KNN, which would compare a pixel to the infinitely many background pixels and never return a result, because there are infinitely many computations to perform. The method 300 may further comprise any one or more steps included in pixel typing step 12 in the Appendix.

At 313, the method 300 may comprise writing a KNN-inferred iₘₐₛₖ PNG file according to the steps detailed in pixel typing step 13 of the Appendix.

At 314, the method 300 may comprise make one or more biopsy/non-biopsy predictions. For example, biopsy/nonbiopsy prediction validates the system because this prediction is based on algorithms that measure the tissue pixels noted in iₘₐₛₖ. To measure the tissue pixels in iₘₐₛₖ, the system may accurately classify pixels of ijpg as tissue or not. The method 300 may comprise one or more steps as detailed in pixel typing step 14 of the Appendix.

At 315, the method 300 may comprise performing ridge detection. For example, a ridge identifies window breaking patterns or bubbles. For the present system's purposes, a ridge is a pixel with an edge type in iₘₐₛₖ. This is a dark/black pixel that has adjacent lighter/background pixels and nearby non-adjacent lighter/background pixels. A Sobel filter may be implemented to identify edges, and an Otsu on the Sobel magnitudes to classify a pixel type as edge/non-edge. An edge pixel is grown outwards to adjacent edge pixels, such that all involved edge pixels are typed as ridges. This allows edge pixels that would not themselves be considered ridges to take the ridge type. Canonically in image analysis, a ridge is a contiguous path of edge pixels. For example, all black type pixels are checked for adjacent background pixels and nearby non-adjacent background pixels. If there are not background pixels in such spatial arrangements around the black pixel, then the pixel is not a ridge. Additionally, a ridge pixel must at the center of an edge (e.g. a bubble's edge), which counterintuitively means Sobel magnitude must be less than otsu_{sobel}. Ridge pixels are saved to ridge_ary and ridge_pixel_coords to visualization and efficient enumeration. For example, the ridge_pixel_iteration checks that a black pixel satisfies all the requirements of a ridge pixel, returning true if so, false otherwise. The black pixel must have Sobel magnitude less than otsu_{sobel}, or else there may appear to be an “edge” on either side of a bubble's boundary. The black pixel may have an adjacent pixelₘₐₛₖ of the background type. Additionally, the black pixel may have a background pixel nearby (i.e. neighborhood_offset pixels away in one of the 8 cananonical directions of up,up-right,right, down-right, down, down-left,left,up-left). If all these criteria are met the black pixel may be typed as a ridge. Multiple checks for background pixels, both adjacent and nearby, are important because there may be glands, lumen, adipocytes, etc in tissue. These extra checks help avoid pixels taking spurious ridge types. Additionally, ridge detection (e.g., edges of bubbles) and stain strength detection may be combined to determine one or more acrylamide age statistics (e.g., slide degeneration statistics). The method 300 may comprise one or more steps detailed in pixel typing step 15 of the Appendix.

At 316, the ledge PNG file may be written. The method 300 may comprise one or more steps as detailed in pixel typing step 16 of the Appendix.

At 317, the method 300 may comprise determining (e.g., detecting) one or more barcodes and/or personal health information/personally identifiable information (PHI/PII). For Example, the system may compare how many dark/black pixels are set against light/background pixels, on both the left and right sides of a slide. If there is a sticker or some printed black text that may disclose PHI/PII, this text is expected to be on the left side or the right side, but never both sides at the same time. This printed text may be on a black-and-white sticker. Thus, by comparing the dark/light differences on the left to right sides, PHI/PII is most likely to be disclose when one side has many more dark-against-light pixels than the other side. The method 300 may comprise one or more steps as detailed in pixel typing step 17 of the Appendix.

At 318, one or more timing statistics may be determined. For example, the system may determine how long it took to perform the method 300. The method 300 may comprise one or more steps as detailed in pixel typing step 18 of the Appendix.

The method 300 may comprise auditing for PHI/PII.

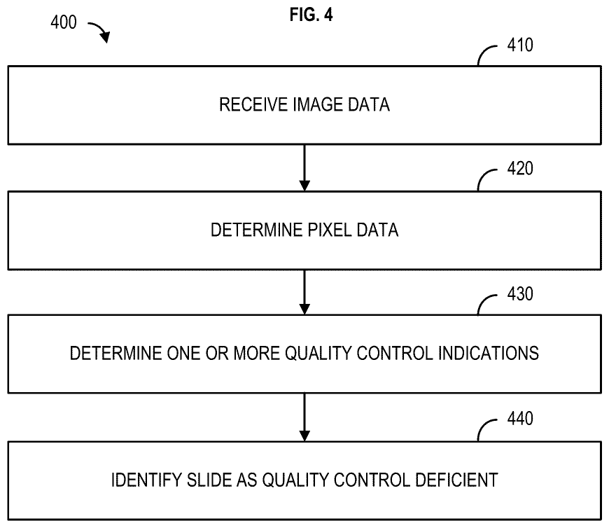

FIG. 4 shows an example method 400 in accordance with embodiments of the disclosure. The example method 400 may be carried out via any one or more of the devices described herein, including components of the system 100 of FIG. 1, such as the computing device 101. At 410, image data may be received. For example, the image day may comprise one or more image files. The image data may be associated with one or more slides. For example, the image data may be associated with one or more slides of tissue. The image data may comprise one or more files. For example, the image data may comprise a glass slide (e.g., i_{glass}). For example, the image data may comprise one or more whole slide images (e.g., i_{wsi}). A whole slide image may be produced by a Leica Aperio GT450 scanner or other similar technologies. The i_{wsi} may comprise one or more components. For example, the i_{wsi} may comprise a small summary i_{thumb} image and a large i_{pyramid} imaging data payload component. i_{pyramid} has pixel data at high resolution typically suitable for diagnosis or downstream AI analysis. The image data may comprise one or more PNG files. For example, the total magnification of i_{png} may be 100×, which may offer enough magnification to view nuclei. The image data may comprise one or more JPG files (ijpg). For example, ijpg be a JPG image file that is downsampled i_{png}, such that total magnification in ijpg is 10×. Downsampling means the image is scaled down and made smaller. For instance, if a 1000×100 pixel image is downsampled 10×, the resulting image is 100×10 pixels. The image data may comprise one or more iₘₐₛₖ files (as described herein and in the Appendix). For example, iₘₐₛₖ may be a quality control mask produced by the system. The iₘₐₛₖ pixels may be a semantic segmentation of the ijpg pixels. That is, an iₘₐₛₖ pixel may indicate the system's prediction for what type of pixel exists at the corresponding ijpg coordinate (e.g. is the pixel background, tissue, pen, suspect, an edge, etc). The height and width of ijpg and iₘₐₛₖ may be identical, because each pixel in ijpg corresponds to the pixel in iₘₐₛₖ at the same cartesian coordinate. The image data may comprise one or more i_{edge} files. For example, the one or more ledge files may comprise a quality control mask produced by the system for the purposes of illustrating edge and ridge detection. This primarily visualizes results from the system's Sobel filter. The one or more ledge files may be considered in addition to iₘₐₛₖ to visualize how the system types each pixel. The image data may comprise one or more i_{thumb} files. For example, the one or more i_{thumb} files may comprise a thumbnail image from i_{wsi}. The i_{thumb} image may be mebabytes or smaller in size. Typically, the whole slide scanner produces i_{thumb} to easily view manually the contents of the slide at very low magnification. The image data may comprise one or more i_{pyramid} files. For example, the one or more i_{pyramid} files may comprise one or more high resolution scans of one or more levels of magnification. For example, L0 (level 0) is the highest-magnification level in the image pyramid, e.g. 400× magnification. There are typically so many pixels in L0 that this image cannot be directly exported to a PNG image file. Such high magnification is not necessarily required for quality control. Nuclei are plainly visible in L0. Loosely speaking, L0 is the “base” or “ground” level of the “pyramid”. L1 (level 1) is the second-highest magnification level, and is typically downsampled 4× from L0. Therefore L1 is typically 100× total magnification, which is just enough magnification for nuclei to be visible. Depending on the configuration of the scanner, more levels may be produced at progressively lower magnification. For example, L2 is often 16× downsampled from L0, but this may vary from 8-32×, depending on the scanner's configuration. L3 may be 32× downsampled from L0, this this may vary. i_{png}, ijpg, and iₘₐₛₖ are all derived from L1 in the image pyramid, because the image pyramid is the data of interest in i_{wsi} for diagnosis and downstream AI applications. Although ijpg and iₘₐₛₖ are very small in size, ijpg and iₘₐₛₖ are not based on i_{thumb} which is also small in size. The image data may comprise one or more pixels.

At 420, information associated with the one or more pixels in the image data may be determined. For example, the information associated with the one or more pixels in the image data may comprise color information associated with one or more color channels (e.g., one or more red channels, one or more blue channels, one or more green channels, combinations thereof, and the like). For example, the information associated with the one or more pixels in the image data may comprise one or more of: color Information (e.g., each pixel typically encodes color information, which can be represented using various color models such as RGB (Red, Green, Blue), CMYK (Cyan, Magenta, Yellow, Key/Black), grayscale, or others. RGB is the most common color model in digital images, where each pixel's color is described by its intensity in these three primary color channels), spatial location information (e.g., pixels are arranged in a grid, and their positions within the grid convey spatial information, and the arrangement of pixels defines the image's width and height, and the coordinates of each pixel specify its location within the image), Intensity or Brightness (e.g., each pixel's value represents its intensity or brightness, with higher values indicating lighter shades and lower values indicating darker shades and in color images, the intensity information is typically combined with color information), transparency or alpha channel (e.g., in images with transparency (e.g., PNG images), an additional channel, known as the alpha channel, is used to represent the level of transparency for each pixel, this allows for the creation of images with partially transparent or semitransparent regions), depth or z-buffer Information (e.g., in some cases, especially in 3D rendering or medical imaging, image data may include a depth or Z-buffer channel, which represents the distance of each pixel from the viewer. This information is used for rendering 3D scenes and creating depth-of-field effects), metadata: Image files often contain metadata, such as EXIF data, which includes information about the camera settings, capture date and time, GPS coordinates (if available), and other details related to the image's creation; texture and pattern information: Pixels in an image may collectively represent textures, patterns, or details present in the scene. These details can be important for various image processing tasks, such as texture analysis or pattern recognition. The information may comprise compression artifacts. For example, depending on the image format and compression settings, pixel data may also contain artifacts introduced during image compression. These artifacts can affect image quality. The information may comprise histogram information. For example, histograms of pixel values can be computed to analyze the distribution of colors or intensities in an image. This information is useful for various image processing and analysis tasks. The information may comprise semantic or object information: In the context of computer vision and image analysis, pixels may be associated with semantic labels or object identification. For instance, in image segmentation, pixels are classified into different object categories.

At 430, one or more quality control indications may be determined. Determining the one or more quality control indications may comprise one or more of: determining the image data comprises one or more photomicrographs, determining one or more preliminary pixel types associated with one or more pixels, determining the presence of debris, determining one or more edges in the image data, determining one or more horizontal bars and/or one or more vertical bars that may be indicative of blurring, determining one or more suspect pixels, converting the one or more suspect pixels to black pixels, detecting pen, converting one or more suspect pixels to one or more pen type pixels, determining one or more systematic blur thresholds, determining one or more slide age estimates, determining one or more tissue crispness statistics, determining one or more systematic blur statistics, determining one or more slide age metrics (e.g., by virtue of stain strength and/or systematic blur), writing one or more raw iₘₐₛₖ PNG files, determining one or more contiguity measurements, determining one or more stitching scores (e.g., determining one or more stitching artifacts, one or more blur boundaries), writing one or more mean iₘₐₛₖ PNG files (e.g., one or more iₘₐₛₖ mixed with one or more ijpg files), performing one or more accelerated KNN inferences configured to convert the one or more suspect pixels to one or more other pixel types, writing one or more KNN-inferred iₘₐₛₖ PNG files, making one or more biopsy/non-biopsy predictions, performing ridge detection, determining one or more acrylamide age statistics (e.g., indicative of slide degeneration), writing one or more ledge PNG files, determining one or more barcodes in the image data, determining one or more indications of personal health information/

At 440, the slide may be indicated as quality control deficient. The slide may be indicated as quality control deficient based on the one or more quality control indications.

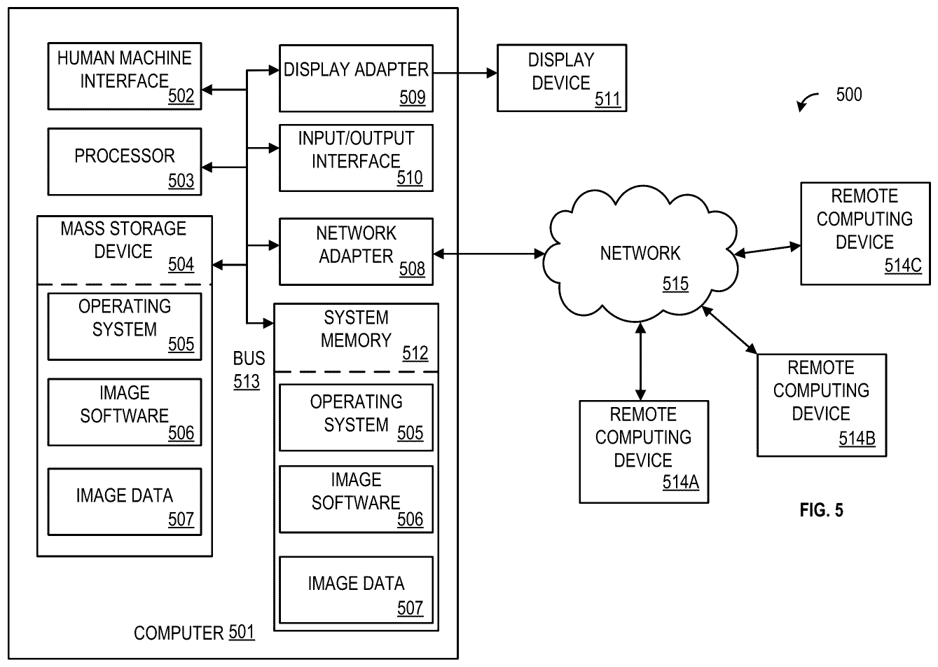

FIG. 5 shows a system 500 for error correction in accordance with embodiments of the present disclosure. The system 500 includes a computer 501. The computer 501 may implement the computing device 101 of FIG. 1, in some examples. The computer 501 may be configured to (e.g., store processor executable instructions that cause the computer 501 to) perform the method 200 of FIG. 2, the method 300 of FIG. 3, and/or the method 400 of FIG. 4, in some examples. The computer 501 may comprise one or more processors 503, a system memory 512, and a bus 513 that couples various system components including the one or more processors 503 to the system memory 512. In the case of multiple processors 503, the computer 501 may utilize parallel computing. The bus 513 is one or more of several possible types of bus structures, including a memory bus or memory controller, a peripheral bus, an accelerated graphics port, or local bus using any of a variety of bus architectures.

The computer 501 may operate on and/or comprise a variety of computer readable media (e.g., non-transitory media). The readable media may be any available media that is accessible by the computer 501 and may include both volatile and non-volatile media, removable and non-removable media. The system memory 512 has computer readable media in the form of volatile memory, such as random access memory (RAM), and/or non-volatile memory, such as read only memory (ROM). The system memory 512 may store data such as image data 507 and/or program modules such as the operating system 505 and image software 506 that are accessible to and/or are operated on by the one or more processors 503. The image data 507 may include, for example, one or more hardware parameters and/or usage parameters as described herein. The image software 506 may be used by the computer 501 to cause one or operations.

The computer 501 may also have other removable/non-removable, volatile/non-volatile computer storage media. FIG. 5 shows the mass storage device 504 which may provide non-volatile storage of computer code, computer readable instructions, data structures, program modules, and other data for the computer 501. The mass storage device 504 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules may be stored on the mass storage device 504, such as the operating system 505 and the image software 506. Each of the operating system 505 and the image software 506 (e.g., or some combination thereof) may have elements of the program modules and the image software 506. The image data 507 may also be stored on the mass storage device 504. The image data 507 may be stored in any of one or more databases known in the art. Such databases may be DB2®, Microsoft® Access, Microsoft® SQL Server, Oracle®, mySQL, PostgreSQL, and the like. The databases may be centralized or distributed across locations within the network 515.

A user may enter commands and information into the computer 501 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like. These and other input devices may be connected to the one or more processors 503 via a human machine interface 502 that is coupled to the bus 513, but may be connected by other interface and bus structures, such as a parallel port, game port, an IEEE 1397 Port (also known as a Firewire port), a serial port, network adapter 517, and/or a universal serial bus (USB).

The display device 511 may also be connected to the bus 513 via an interface, such as the display adapter 507. It is contemplated that the computer 501 may have more than one display adapter 507 and the computer 501 may have more than one display device 511. The display device 511 may be a monitor, an LCD (Liquid Crystal Display), light emitting diode (LED) display, television, smart lens, smart glass, and/or a projector. In addition to the display device 511, other output peripheral devices may be components such as speakers (not shown) and a printer (not shown) which may be connected to the computer 501 via the Input/Output Interface 510. Any step and/or result of the methods may be output (or caused to be output) in any form to an output device. Such output may be any form of visual representation, including, but not limited to, textual, graphical, animation, audio, tactile, and the like. The display device 511 and computer 501 may be part of one device, or separate devices.

The computer 501 may operate in a networked environment using logical connections to one or more devices such as sensing device 102, valve device 302, or user device 310. A remote sensing device may be a sensing device 102, a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 501 one or more devices such as the remote devices 514A-C may be made via a network 515, such as a local area network (LAN) and/or a general wide area network (WAN). Such network connections may be through the network adapter 517. The network adapter 517 may be implemented in both wired and wireless environments. Such networking environments are conventional and commonplace in dwellings, offices, enterprise-wide computer networks, intranets, and the Internet.

Application programs and other executable program components such as the operating system 505 are shown herein as discrete blocks, although it is recognized that such programs and components reside at various times in different storage components of the computing device 501, and are executed by the one or more processors 503 of the computer. An implementation of the image software 506 may be stored on or sent across some form of computer readable media. Any of the described methods may be performed by processor-executable instructions embodied on computer readable media.

### Examples

The following is a non-limiting description of example systems and methods.

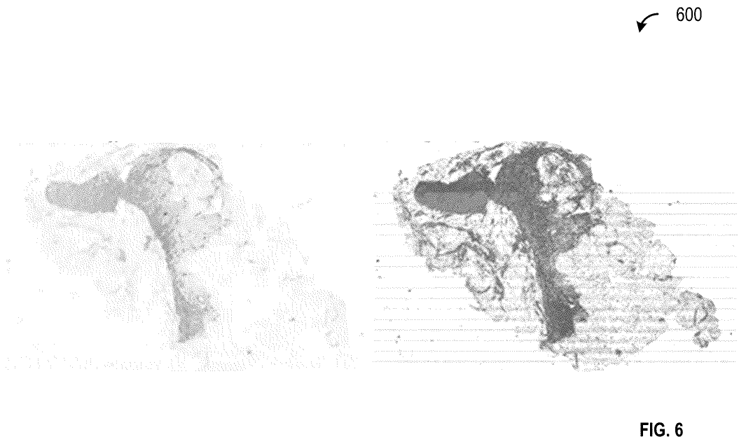

A first feature may include systematic blur detection. The system does not look for blurred pixels directly. Instead, the system look for horizontal lines, which are artifacts that occur when the slide shakes in place. The shaking blurs the image during scanning. It's easier (and perhaps more reliable) to look for these line artifacts than it is to look for blurred pixels directly. A prior patent in pathology quality control detected blur directly, using a Laplacian filter. With a Laplacian filter, a blurred pixel is any pixel that has pixels of the same grayscale intensity around it. This filter gave many false positives for blur in homogeneous stromal regions. In practice, it has been found that blur does not frequently randomly occur throughout an image, so this filter isn't ideal. Instead, for slides being analyzed, it seems systematic blur is more common, where large rigid bands of blurring occur across an image. In contract, the system can detect systematic blur by looking for the “stitching line” artifacts, which iQC indicates as lines in orange. For example, FIG. 6 depicts an example 600 of orange stitching line artifacts in accordance with embodiments described herein.

A second feature may include the way “hematoxylin pixels” are detected. In the prior art, “nuclear pixels” were discussed, which required computationally-intensive steps to identify, including color deconvolution, and taking the difference between the hematoxylin and eosin “channels” in an image. The systems's hematoxylin pixels of this disclosure are much faster to calculate because they are determined based on thresholding the blue and red channels.

Otsu's Method is a long-standing method to automatically determine a threshold in a set of values. Otsu's Method assumes the values are bimodal. The Otsu Threshold splits the set of values into two sets. The Otsu Threshold maximizes the variance between the sets and minimizes the variances within the sets. Otsu's Method offers the system a means to “self-calibrate” a number of thresholds, including foreground/background thresholds and edge/non-edge thresholds. The use of Otsu's Method to distinguish edges from non-edges may be novel, although one could consider the Canny Edge Detector, which took a different thresholding approach. Otsu's Method may be used in tissue score row accumulators in biopsy/nonbiopsy prediction

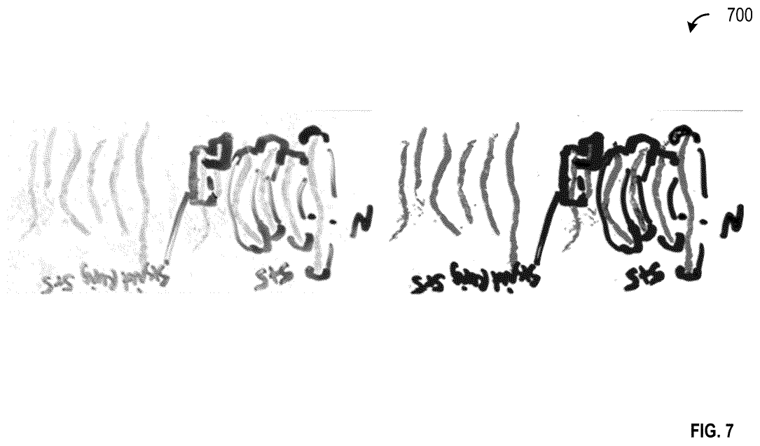

The system may detect pen in a unique way, as compared with the prior patent in pathology quality control, which detected pen on a per-pixel basis. For example, pen is detected at a location in the image, e.g. a strongly red pixel. The system may tentatively extends 8 lines from that location (up, diagonally up-right, right, down-right, down, down-left, left, up-left). If the line up to a specific maximum length connects to another pen of the same color, then both pen locations and the line in between are all pen. Additionally, all other tissue pixels within a specific radius of these points and line are marked as pen. This has several benefits: First, some false positives may be avoided for one-off pixels that may appear to be pen, because the system require multiple pen pixels of the same color to be near each other, spanning only tissue (or suspect pixels) in between. In addition, from the pre-programmed thresholds for red, green, blue, black, etc pen the system can learn in the image what other pixels may be this pen color. For instance, unsaturated red pixels may be in between two points of red pen, so evidence that pixels of this unsaturated red color are also red pen may be present. These unsaturated pixels are produced from the nature of the pen stroke: as a pen stroke is drawn, the pixels in between starting and ending points of a pen stroke tend to be less saturated in color as the pen ink is “drawn out”, and it is difficult to program “a priori” exactly what these unsaturated pen pixels will look like. FIG. 7 depicts an example 700 of pen in accordance with embodiments described herein. This evidence of unsaturated pen color is important for “accelerated scalable K-nearest-neighbor (KNN)” search, because anywhere in the image that identical unsaturated pen pixels are found, the KNN algorithm will then infer those pixels as pen. This gives the system a degree of flexibility in how pen is defined within an image, and is the core of the artificial intelligence component of iQC. Accelerated scalable K-nearest-neighbor (KNN) search. Uses a hashtable/dictionary. Doesn't compare one pixel to all other pixels, rather checks if a pixel (of an unknown class) has an exact match to a pixel (of a known class) in the image already. Then the pixel's unknown class is inferred to the known class. This is typically used on the “suspect” pixels indicated in orange. The task is to use KNN quickly to infer suspect pixels as background (the white/clear/empty part of a slide), tissue, pen, or marker. After inference, there is a better estimate of how much tissue there is in a slide and where the tissue is, so high-level image statistics for biopsy/nonbiopsy prediction may be calculated robustly. Only after attempting hashtable/dictionary lookups of a pixel, and pixels with similar values, is a more naïve KNN search performed that compares this pixel's value to all other unique pixel values in the image. Still, by considering only unique pixel values, the algorithm is much faster and scales well.

The system may be used for biopsy/nonbiopsy prediction. It leverages several algorithms, each algorithm generates a score, each score is run through a Gompertz function, and various Gompertz functions are multiplied or added together to get a final score. If the final score is high, there is greater evidence this image is not a biopsy (a.k.a. “nonbiopsy”). Low scores suggest a biopsy. This predictor is really valuable, because a randomized mix of biopsy and nonbiopsy slides may be received. Additionally, the system may not have access to a comprehensive list of the CPT codes (e.g., medical procedure codes) for each of these slides, which could specify if the patient's procedure was a needle biopsy, transurethral resection (nonbiopsy), radical prostate ectomy (nonbiopsy), or some other tissue with a prostate cancer metastasis (e.g. lymph node, bone, colon, etc-all nonbiopsy). Thus, this this classifier simply looks at the visual appearance of the sample and can communicate with high confidence if this is a biopsy or not. Downstream AI analysis and scientific studies may focus solely on biopsies, for instance, and ignore nonbiopsies. The choice to use a Gompertz function is important. The Gompertz function may be defined to be mostly flat, then rise sharply, then taper off to reach a maximum value gradually. This flat region that is near zero is valuable. If many Gompertz function outputs are multiplied together, if any Gompertz function output is close to zero due to this flat region, then the product of the multiplication is also near zero. This allows one line of evidence to “veto” the nonbiopsy prediction, effectively forcing the prediction to be near zero and indicate the sample is a biopsy. This property may be leveraged extensively. A Gompertz output is near zero if there is little tissue in the slide, because biopsies typically excise far less tissue than an ectomy. Therefore having little tissue in the slide drives the biopsy predictor to zero, to favor a prediction of biopsy. Similarly, if iQC algorithms determine the shape of the tissue long and thin. The biopsy/nonbiopsy prediction's structure is as follows, with the final biopsy/nonbiopsy score prediction being “qc_ectomy_not_biopsy_incl_bg_adjacent_stroma_score_sigmoid”. This score is high for ectomy/TURP/other-nonbiopsy, low for biopsy. The score is based on the narrowest extent of tissue (biopsies are thin), the amount of tissue (nonsuspect tissue includes inferred nonsuspect pixels, ectomies have more tissue), and the ratio of height-to-width of the tissue (biopsies are long and thin, while ectomies are rectangular). None of these measures are perfect indicators of biopsy/non-biopsy, but combined they may be more accurate at classification. The bg_adjacent_tissue_ratio_sigmoid_score term, may be added in, which makes fatty ectomies classify as ectomies not biopsies. The overall score may be capped at 100000, which is 100*100*100 (the three main constituent scores multiplied together). This cap makes it intuitive to convert this score to something between 0 and 1, which looks like a probability.

A number of algorithms that generate important statistics to assess the quality of the image, as alluded to above (e.g. mmts is a statistic), but there are many more statistics. These are typically shown in some way in internal reports. Additionally, each slide has a metadata file with all of its calculate metrics.

Slide aging metrics. Fresh slides have vibrant color. Aged fades lose that, just as a vibrantly red car's color fades under years of sunlight. The system may use a metric to calculate the difference between the (red and blue channels) from the (green channel) in the tissue in the image to assess how faded the slide is. If there is a small difference, the slide is faded. If fading exceeds a threshold, the system fails the slide or recommends it for review.

Bubble detection-Acrylamide in the slide breaks down with time, forming “window pane breaking” artifacts and bubbles. The system calculates metrics to assess how much of a bubble's interface extends over the background of the slide. Poorer quality slides as have more of this. If this exceeds a threshold, the system fails the slide or recommends it for review.

Barcode/text detection. Do not want to have patient names or PHI/PII printed on slide. iQC identifies where black text is printed on the slide, and how much. If this exceeds a threshold, the system recommends the slide for review. Perhaps the slide should be better physically oriented in the scanner to avoid the text, or an opaque sticker applied over the text to protect PHI/PII.

Debris detection. Excessive debris may partially occlude disease foci in the slide. If this exceeds a threshold, iQC recommends the slide for review. Perhaps the slide should be cleaned and rescanned.

Inadequate tissue detection. If the slide is mostly empty and has almost no tissue, then the system recommends the slide for review. This may be an inadequate biopsy. Inadequate tissue in general may make forming a diagnosis impossible.

Reporting, the system may generate many different types of reports.

Internal reporting. This is an HTML file, which is essentially a web page, but it's just a file. It's intended for internal use. This may be used to inspect the system results, check that the system results are reasonable, and cherry-pick particularly poor quality images. There may be trends, e.g. if many poor quality images some from a specific institution/site, then perhaps this site makes slides in a different way or stored slides under poor conditions so all the slides have deteriorated. This is called a batch effect. The whole batch of slides may be bad. The internal reporting tool of the system, for instance, may include a systematic blur detector, and the internal report may indicate the slides with the strongest evidence of systematic blur. By identifying the “worst” slides in any particular category, like systematic blur, it is possible to triage slides for manual review. By manually reviewing the “worst” slides first, considerable time is saved, compared to looking at slides in no particular order, where most slides are of good quality. The internal reporting tool has many categories, e.g., the slides with the most blue pen, or other slides with the most debris, or most slide fading, etc. The internal reporting tool only reports a slide once. If a slide has ever been reported for any category, it is never reported again for any other category. This ensures that the internal report does not show redundant information. Redundant information may waste a reviewer's time.

External reporting. These are XLSX/Excel spreadsheets. They have slide IDs, quality control status, small pictures of the slide and corresponding quality control image from iQC. Spreadsheets are necessary for security purposes, such as being used at a secure site. That is, all users may not be given open access to the system, but spreadsheets can be generated, and may be reviewed by Data Operations experts to be sure the spreadsheets are safe to share (e.g., no PHI/PII, no protected data from our secure site, no illegal data exfiltration, etc), and then the spreadsheets may be placed in a shared folder for inspection. This a way to get quality control feedback to users. In principle, a website could be implemented to share data, but the secure requirements are very high. The website would need to undergo extensive penetration testing and other security testing. There are a variety of external report formats: 1. “all”: these is a single spreadsheet of all slides. It's a large spreadsheet and may be difficult to load on a computer. Certain aspects of reporting may be unique. For example, the spreadsheet may include a small image of the whole slide to facilitate manual review. The small image may be derived from scaling down a medium-magnification slide from the “image pyramid” in the whole slide image. The small image is NOT derived from the thumbnail image. This is important security consideration. For security, thumbnails may be stripped from whole slide images. A thumbnail in the whole slide image may contain a patient name, barcode, or other PHI/PII. By removing thumbnail information, a de-identified research-ready dataset from whole slide images is generated. For security, the small image based on the “image pyramid” will show a manual reviewer if there is any patient name or PHI/PII in the whole slide image. The system “barcode detector” also tries to detect printed patient names in the image pyramid. The image pyramid cannot be stripped for security reasons, because the image pyramid is the image data of interest in a whole slide image. If this information were stripped out, the whole slide image would be an empty file. Implemented security procedures are three-fold, at a secure site and have a strong mandate to protect servicemember data from PHI/PII leaks, despite such data being shared within for research in a strictly controlled manner: 1. Thumbnails are stripped, which are the most likely component of a whole slide image to have a patient name or other PHI/PII, the system's barcode detector scans a portion of the image pyramid for printed text, such as barcodes and patient names. If the system detects such text etc, the system recommends the slide for manual review. In the external report spreadsheet, all slides are represented by a small image from the image pyramid, to encourage manual review of every slide for patient names or other PHI/PII. Alongside the slide image, a corresponding quality control mask of the image may be presented. For each slide, there are not only images, but also the slide ID, quality control status (pass/review/fail etc), the biopsy/nonbiopsy status, a column to manually curate the biopsy/nonbiopsy status, and the biopsy/nonbiopsy score. A spreadsheet is readily adaptable by users, who may add columns at their own discretion, e.g., a column to track which poor quality slides have been remade as fresh high quality slides. Such tracking in turns allows our spreadsheets to function as a project management tool, which records how quickly slides are being remade, and allows the system to forecast how many slides may be remade in the future. Taken together, the spreadsheet is a comprehensive slide review tool that is readily usable by users.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
receiving image data associated with a slide;
determining, based on the image data, information associated with one or more pixels in the image data;
determining based on the information associated with the one or more pixels in the image data, one or more quality control indications; and
identifying, based on the one or more quality control indications, the slide as quality control deficient.

2. The method of claim 1, further comprising detecting, based on detecting one or more horizontal lines in the image data, blur in the image data.

3. The method of claim 1, further comprising detecting, based on thresholding one or more red channels in the image data and one or more blue channels in the image data, one or more hematoxylin pixels in the image data.

4. The method of claim 1, further comprising distinguishing, based on Otsu's method, edges from non-edges in the image data.

5. The method of claim 1, further comprising determining, based on a first red channel of a first pixel satisfying a threshold and one or more second red channels associated with one or more second pixels satisfying the threshold, wherein the one or more second pixels are contiguous with the first pixel, one or more pen markings in the image data.

6. The method of claim 1, determining, based on a k-nearest-neighbor (KNN) search, one or more suspect pixels in the image data, wherein the one or more suspect pixels are identified as one or more of: background, tissue, pen, or marker pixels.

7. The method of claim 1, further comprising determining, based on a Gompertz function applied to the image data, a biopsy prediction associated with the image data.

8. The method of claim 1, further comprising determining, based on one or more of: one or more slide aging metrics, barcode detection, text detection, debris detection, or inadequate tissue detection, a slide quality metric, wherein the one or more slide aging metrics comprise one or more of: color vibrancy or bubble detection.

9. The method of claim 1, further comprising generating one or more reports.

10. An apparatus comprising:
one or more processors; and
a memory storing processor-executable instructions that, when executed by the one or more processors, cause the apparatus to:
receive image data associated with a slide;
determine information associated with one or more pixels in the image data;
determine based on the information associated with the one or more pixels in the image data, one or more quality control indications; and
identify, based on the one or more quality control indications, the slide as quality control deficient.

11. The apparatus of claim 10, wherein the processor-executable instructions, when executed by the one or more processors, further cause the apparatus to detect, based on detecting one or more horizontal lines in the image data, blur in the image data.

12. The apparatus of claim 10, wherein the processor-executable instructions, when executed by the one or more processors, further cause the apparatus to detect, based on thresholding one or more red channels in the image data and one or more blue channels in the image data, one or more hematoxylin pixels in the image data.

13. The apparatus of claim 10, wherein the processor-executable instructions, when executed by the one or more processors, further cause the apparatus to distinguish, based on Otsu's method, edges from non-edges in the image data.

14. The apparatus of claim 10, wherein the processor-executable instructions, when executed by the one or more processors, further cause the apparatus to determine, based on a first red channel of a first pixel satisfying a threshold and one or more second red channels associated with one or more second pixels satisfying the threshold, wherein the one or more second pixels are contiguous with the first pixel, one or more pen markings in the image data.

15. The apparatus of claim 10, wherein the processor-executable instructions, when executed by the one or more processors, further cause the apparatus to determine, based on a k-nearest-neighbor (KNN) search, one or more suspect pixels in the image data, wherein the one or more suspect pixels are identified as one or more of: background, tissue, pen, or marker pixels.

16. The apparatus of claim 10, wherein the processor-executable instructions, when executed by the one or more processors, further cause the apparatus to determine, based on a Gompertz function applied to the image data, a biopsy prediction associated with the image data.

17. The apparatus of claim 10, wherein the processor-executable instructions, when executed by the one or more processors, further cause the apparatus to determine, based on one or more of: one or more slide aging metrics, barcode detection, text detection, debris detection, or inadequate tissue detection, a slide quality metric, wherein the one or more slide aging metrics comprise one or more of: color vibrancy or bubble detection.

18. The apparatus of claim 10, wherein the processor-executable instructions, when executed by the one or more processors, further cause the apparatus to generate one or more reports.

19. One or more non-transitory computer-readable media storing processor executable instructions that, when executed by at least one processor, cause the at least one processor to:
receive image data associated with a slide;
determine information associated with one or more pixels in the image data;
determine based on the information associated with the one or more pixels in the image data, one or more quality control indications; and
identify, based on the one or more quality control indications, the slide as quality control deficient.

20. The one or more non-transitory computer-readable media of claim 19, wherein the processor-executable instructions, when executed by the at least one processor, further cause the at least one processor to detect, based on detecting one or more horizontal lines in the image data, blur in the image data.

21. The one or more non-transitory computer-readable media of claim 19, wherein the processor-executable instructions, when executed by the at least one processor, further cause the at least one processor to detect, based on thresholding one or more red channels in the image data and one or more blue channels in the image data, one or more hematoxylin pixels in the image data.

22. The one or more non-transitory computer-readable media of claim 19, wherein the processor-executable instructions, when executed by the at least one processor, further cause the at least one processor to distinguish, based on Otsu's method, edges from non-edges in the image data.

23. The one or more non-transitory computer-readable media of claim 19, wherein the processor-executable instructions, when executed by the at least one processor, further cause the at least one processor to determine, based on a first red channel of a first pixel satisfying a threshold and one or more second red channels associated with one or more second pixels satisfying the threshold, wherein the one or more second pixels are contiguous with the first pixel, one or more pen markings in the image data.

24. The one or more non-transitory computer-readable media of claim 19, wherein the processor-executable instructions, when executed by the at least one processor, further cause the at least one processor to determine, based on a k-nearest-neighbor (KNN) search, one or more suspect pixels in the image data, wherein the one or more suspect pixels are identified as one or more of: background, tissue, pen, or marker pixels.

25. The one or more non-transitory computer-readable media of claim 19, wherein the processor-executable instructions, when executed by the at least one processor, further cause the at least one processor to determine, based on a Gompertz function applied to the image data, a biopsy prediction associated with the image data.

26. The one or more non-transitory computer-readable media of claim 19, wherein the processor-executable instructions, when executed by the at least one processor, further cause the at least one processor to determine, based on one or more of: one or more slide aging metrics, barcode detection, text detection, debris detection, or inadequate tissue detection, a slide quality metric, wherein the one or more slide aging metrics comprise one or more of: color vibrancy or bubble detection.

27. The one or more non-transitory computer-readable media of claim 19, wherein the processor-executable instructions, when executed by the at least one processor, further cause the at least one processor to generate one or more reports.
